(19) United States
(12) Patent Application Publication
(10) Pub. No.: US 2023/0262447 A1
(43) Pub. Date: Aug. 17, 2023

(54) METHOD AND APPARATUS TO SUPPORT DUAL PACKET SWITCHED SERVICE IN UE

(71) Applicant: INNOPEAK TECHNOLOGY, INC., Palo Alto, CA (US)

(72) Inventors: Xin Xu, Palo Alto, CA (US); Jaehyeuk Yang, Palo Alto, CA (US); Yongsheng Shi, Palo Alto, CA (US)

(21) Appl. No.: 18/136,653

(22) Filed: Apr. 19, 2023

Related U.S. Application Data
(63) Continuation of application No. PCT/US2021/056088, filed on Oct. 21, 2021.
(60) Provisional application No. 63/104,359, filed on Oct. 22, 2020.

(51) Int. Cl. H04W 8/20; H04W 76/10

(52) U.S. Cl. CPC H04W 8/20; H04W 76/10

(57) ABSTRACT

Systems and methods are provided for enabling dual subscriber identity module (SIM) card usage for accessing packet switched services/networks. Each of the dual SIM cards operate in an always on mode and can be used to establish and maintain data connections over which the packet switched services/networks can be engaged. The dual SIM cards can be used in the aggregate or separately according to dynamic selection or fixed/mapped associations between an application requesting to access the packet switched services/networks and one or more of the dual SIM cards.

### CROSS-REFERENCE TO RELATED APPLICATIONS

This application is a continuation of International Application No. PCT/US2021/056088 filed on Oct. 21, 2021, and claims the benefit of U.S. Provisional Application No. 63/104,359 filed Oct. 22, 2020 and which are hereby incorporated herein by reference in their entireties.

### FIELD

The disclosed technology relates generally to dual subscriber identity module (SIM) card devices, and more particularly to enabling optimal usage of the dual SIM cards to facilitate communications such as packet switched (PS) communications/services.

### BACKGROUND

A dual SIM device, such as a dual SIM smartphone, can refer to a device that can include or use two separate SIM cards. Depending on the type of dual SIM device, each of the two SIM cards can be active at the same time, i.e., a DSDA device, where a user can make/receive calls from/to both SIM cards. In a dual SIM dual standby (DSDS)-type device, only one of the two SIM cards can be used at any given time, and a user selects which of the two SIM cards is to be used. On the other hand, a DSDS-type device allows the device to have two active SIM cards that can both be reached/receive communications at any time, so long as both of the SIM cards are in standby mode.

### TERMS

The following acronyms are used throughout the drawings and/or descriptions, and are provided below for convenience although other acronyms may be introduced:
PS: Packet Switched
DS: Dual SIM
DSDS: Dual Sim Dual Standby
DSDA: Dual Sim Dual Active
DDS: Default Data Subscription
nDDS: non-Default Data Subscription
PDS: Primary Data Subscription
SDS: Secondary Data Subscription
HLOS: High level operating system
WWAN: Wireless Wide Area Network
DSPM: Data Subscription Policy Manager

### SUMMARY

Dual PS service can be supported by two connections between AP and modem all the time.

In accordance with one embodiment, a user equipment (UE) may comprise a processor; and a memory unit operatively connected to the processor and including instructions that when executed cause the processor to: determine desired operating characteristics associated with data to be communicated to or from the UE; determine possible data connections over which to send or receive the data to be communicated, the possible data connections comporting with usage of at least one of a plurality of subscriber identity module (SIM) cards installed in the UE; and establish a data connection between an application running on the UE and a modem of the UE using the at least one of the plurality of SIM cards.

In some embodiments, each of the SIM cards installed in the UE is associated with a data subscription.

In some embodiments, a first of the SIM cards is associated with a primary data subscription and wherein a second of the SIM cards is associated with a secondary data subscription.

In some embodiments, each of the plurality of SIM cards operates in an always on mode relative to a modem of the UE.

In some embodiments, the determination of the desired operating characteristics associated with data to be communicated to or from the UE is performed repeatedly.

In some embodiments, the determination of the possible data connections depends on updated determinations resulting from the repeated determination of the desired operating characteristics.

In some embodiments, the instructions that when executed establish the data connection between the application running on the UE and the modem of the UE using the at least one of the plurality of SIM cards further comprise establishing another data connection between the application running on the UE and the modem of the UE using the other of the at least one of the plurality of SIM cards.

In some embodiments, the instructions that when executed establish the data connection between the application running on the UE and the modem of the UE using the at least one of the plurality of SIM cards further comprise establishing simultaneously-used data connections between the application running on the UE and the modem of the UE using each of the plurality of SIM cards.

In some embodiments, the instructions that when executed establish the data connection between the application running on the UE and the modem of the UE using the at least one of the plurality of SIM cards further comprise establishing another data connection between the application running on the UE and the modem of the UE using the other of the at least one of the plurality of SIM cards, and switching between the data connection and the other data connection.

In accordance with another embodiment, a user equipment may comprise: a processor; and a memory unit operatively connected to the processor, and including instructions which when executed by the processor comprise a data subscription policy manager to: receive a request from an application being executed by the processor to access a packet switched service; determine desired operating characteristics associated with the access to the packet switched service; select a data path over which to send or receive the data according to the desired operating characteristics by utilizing at least one of a plurality of always-on subscriber identity module (SIM) cards installed in the UE top establish the data path over a network; and establish the data path between the application and the packet switched service.

In some embodiments, selection of the data path is based on a determined mapping between the application and the one of the plurality of always-on SIM cards.

In some embodiments, selection of the data path is dynamic based on the determined desired operating characteristics.

In some embodiments, the desired operating characteristics comprise at least one of application-specific operating characteristics, UE-specific operating characteristics, and network-specific operating characteristics.

In some embodiments, the instructions that when executed establish the data path between the application and the packet switched service further comprise establishing another data path between the application and packet switched service using another one of the plurality of SIM cards.

In some embodiments, the instructions that when executed establish the data path between the application and the packet switched service further comprise establishing simultaneously-used data paths between the application and at least one of the packet switched service and another packet switched service.

In some embodiments, the instructions that when executed establish the data path between the application and the packet switched service further comprise establishing another data path between the application and at least one of the packet switched service and another packet switched service, and switching between the data path and the other data path.

In accordance with yet another embodiment, a method may comprise: determining desired operating characteristics associated with data to be communicated to or from user equipment (UE); determining possible data connections over which to send or receive the data to be communicated, the possible data connections comporting with usage of at least one of a plurality of subscriber identity module (SIM) cards installed in the UE; and establishing a data connection between an application running on the UE and a packet switched service via a modem of the UE using the at least one of the plurality of SIM cards.

In some embodiments, each of the plurality of SIM cards is in an always-on mode of operation.

In some embodiments, the determining of the possible data connections is based on a mapping of the application to the one of the plurality of SIM cards.

In some embodiments, the determining of the possible data connections is dynamically performed based on the determined desired operating characteristics.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example network in which embodiments disclosed herein may be implemented in accordance with some embodiments.

FIG. 2 illustrates an example of a conventional user equipment (UE) having multiple SIM cards.

FIG. 3A illustrates an example of a UE configured to support dual packet switched (PS) service in accordance with one embodiment.

FIG. 3B illustrates the UE of FIG. 3A configured to support dual packet switched (PS) service in accordance with another embodiment.

FIG. 4 illustrates example operations for effectuating dual PS service support in accordance with some embodiments.

FIG. 5 is an example computing component that may be used to implement various features of embodiments described in the present disclosure.

The figures are not exhaustive and do not limit the present disclosure to the precise form disclosed.

### DETAILED DESCRIPTION

As alluded to above, devices may operate using two SIM cards, where different devices/types of devices may use dual SIM cards in different ways, e.g., the aforementioned DSDS and DSDA modes of operation. It should be understood that SIM cards can refer to subscriber identity modules or similar devices that can comprise an integrated circuit on which an operating system runs for securely storing identification information of a device or that can be used to identify and/or authenticate a subscriber, contact information, etc.

In current/conventional DSDS-type mobile devices design, such a device may only use one SIM for PS service at a time, even if two SIMs cards have been inserted or installed in the DSDS device. Moreover, a user specifies one of the two SIM cards to be used as the DDS for the PS service. The other SIM (nDDS) card cannot be used for typical Internet PS services (web browsing/video streaming/downloading, etc.).

This is mainly due to two limitations: (1) a modem within a device does not support a dual radio mode of operation (where single radio resources are shared by both SIMs); and (2) the HLOS of a device may not support two separate data paths to a modem.

DSDA devices have already overcome the first limitation by supporting dual radios in the modem, but the HLOS of DSDA devices still typically only support one SIM for Internet PS service. For example, when a user of a smartphone attempts to access the Internet, only one of the SIMs is specified or selected by the user to support the DDS. Thus, applications from the device/smartphone side may only use the connection established by the DDS (vis-à-vis the selected SIM card) to download data. The nDDS SIM card cannot be used to connect to a network such as the Internet. It should be understood that a Dual SIM device can contain or comprise two RF radios associated with two different subscriptions. For example, one subscription, the DDS, can be used for work-related communications, while the nDDS can be used for personal communications/use (or vice versa). Thus, a user may have to switch from the DDS to the nDDS (and commensurately from using one of the two SIM cards to using the other one of the two SIM cards) to accommodate certain traffic, e.g., if the DDS is allocated for use with personal communications, the user must manually select the other SIM card when the user accesses/uses a work-related application. As another example, a user or subscriber may wish to pay some amount of money/subscription fee to receive unlimited data for a particular website. In this instance, one of the two SIM cards installed in a device is used to avail the user/subscriber of such a data plan. It should be understood that DDSs can be used/are popular with users that communicate/send/receive data using different data packets.

Accordingly, embodiments of the present disclosure are directed to establishing and maintaining data connectivity between a network or network element and the modem of a UE. Each SIM card can be used to establish a dedicated connection or session, and thus can be associated with distinct DDSs, e.g., a primary DS (PDS) and a secondary DS (SDS). In some embodiments of the present disclosure, a data subscription policy manager can be implemented to manage each dedicated connection or session. Various modes of accessing and utilizing either the PDS or the SDS (and their respective, corresponding SIM cards) are possible. For example, in some embodiments, applications resident and operating on a UE’s HLOS may have selective or aggregative access to either the PDS or SDS. In some embodiments, applications may be allowed to switch between use of the PDS and the SDS for, e.g., load balancing traffic, improving quality of service, and/or to recover from abnormal network events/occurrences.

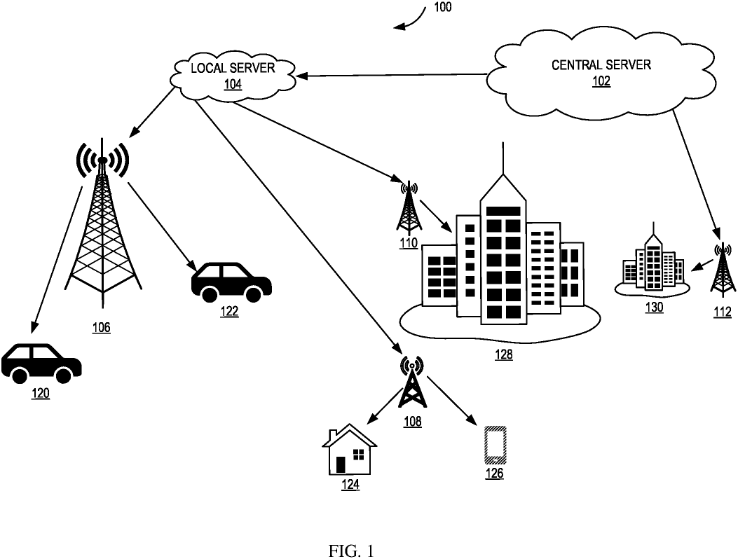

Before describing the details of the various embodiments contemplated herein, it would be beneficial to describe a communications network, such as a cellular or other WWAN to which a DS device may connect. FIG. 1 illustrates an example network 100 in which or with which various embodiments of the present disclosure may be implemented. A mobile network can be thought of as comprising two component networks, the radio access network (RAN) and the core network.

A mobile network’s RAN may include various infrastructure, e.g., base stations/cell towers, masts, in-home/in-building infrastructure, and the like. The RAN allows users of devices (also referred to as user equipment (UE), e.g., smartphones, tablet computers, laptops, vehicle-implemented communication devices (e.g., vehicles having vehicle-to-vehicle (V2V) capabilities), to connect to the core network. FIG. 1 illustrates a plurality of small base stations or small cells and macro base stations or macro cells, i.e., macro cells 106, 110, and 112, and small cell 108.

Macro cells can refer to (tall, high-powered) “macro” base stations/cell towers that are able to maintain network signal strength across long/large distances. Macro cells may use multiple input, multiple output (MIMO) antennas that may have various components that allow data to be sent and/or received simultaneously. In the example network 100 of FIG. 1, macro cell 106 may provide wireless broadband coverage/communications to vehicles 120 and 122. Macro cell 110 may provide broadband service to an area, such as a city or municipality 128. Likewise, macro cell 112 may provide broadband coverage to an area, such as a city or municipality 130.

Small cells can refer to wireless transmitters/receivers implemented as micro base stations designed to provide coverage to areas smaller than those afforded coverage by macro cells, e.g., on the order of about 100 meters (m) to 200 m for outdoor 5G small cells. Indoor 5G small cell deployments may provide coverage on the order about 10 m. Small cells can be mounted or integrated into/onto street lights, utility poles, buildings, etc., and like macro cells, may also leverage massive MIMO antennas. In the example network 100 of FIG. 1, small cell 108 provides broadband coverage to a house 124 and smartphone 126.

The core network may comprise the mobile exchange and data network used to manage the connections made to/from/via the RAN. As illustrated in FIG. 1, the core network of network 100 may include central server 102 and local server 104. Central server 102 is shown to effectuate broadband service to area 130 by way of macro cell 112. Central server 102 may also operatively connect to local server 104, which in turn, provides broadband connectivity by way of macro cells 106 and 110, as well as small cell 108. The use of distributed servers, such as local server 104, can improve response times, thereby reducing latency. The core network may leverage network function virtualization (instantiation of network functions using virtual machines via the cloud rather than hardware) to provide these lower response times, and provide faster connectivity.

As alluded to above, each device or UE, e.g., smartphone, satellite phone, etc. in a communications network may be uniquely identified by some identifying information that can be stored on a SIM card installed therein. SIM cards are typically provided by network operators or service providers. As also noted above, despite being able to support dual radios in the modem of a UE, the operating systems of UEs, e.g., HLOSs of DSDA devices, HLOSs typically still only support the use of a single SIM card for accessing a network, such as the Internet, for communicating PS traffic.

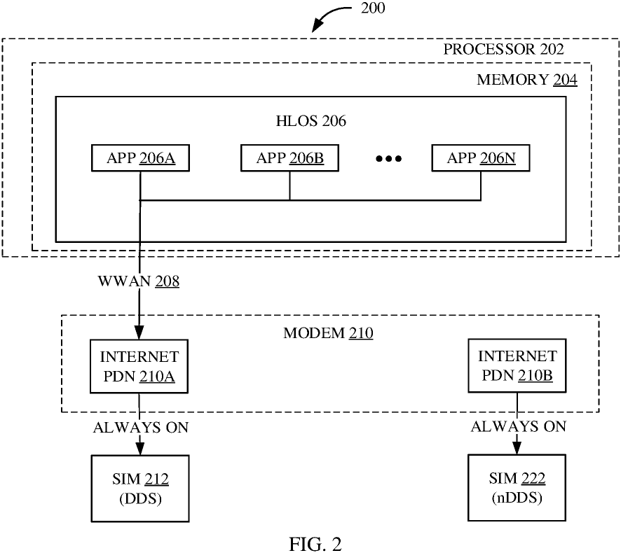

FIG. 2 illustrates a schematic representation of an example UE 200. As illustrated, in one embodiment, UE 200 may comprise a processor 202 or similar computing component capable of processing data. Hardware processor 202 may be one or more central processing units (CPUs), semiconductor-based microprocessors, and/or memory 204. HLOS 206 may be an operating system stored in memory 204 and executed by processor 202, whereby HLOS 206 controls or is involved in executing one or more applications (which may also be stored in memory 204), e.g., applications that may have a need to communicate with/via a network, such as an Internet packet data network 210A or 210B.

As illustrated in FIG. 2, one or more applications 206A, 206B, 206N may utilize only a single data connection. In this example, data connection WWAN 208 can be effectuated between any one or more of applications 206A-206N/HLOS 206 and a modem 210 of UE 200 that maps to Internet PDN 210A (using, e.g., the PD protocol (PDP) or protocol data unit (PDU) session for accessing PS service. As can be appreciated, there is only one data connection (WWAN 208) between HLOS 201 and modem 210 for PS service using one of SIM cards 212, 222, in this example, SIM card 212 which has been designated as being the DDS.

Accordingly, as can be appreciated, despite the existence of another SIM card 222 (designated as the nDDS) that “could” be used to effectuate a PDP/PDU connection/session mapped to Internet PDN 210B, HLOS 206/applications 206A-206N may not utilize SIM card 222. That is, conventional UEs lack flexibility, e.g., all applications (e.g., communications applications, social media applications, etc.) use the DDS which in this case, corresponds to SIM card 212, for Internet PS (while the nDDS is free). However, with the demand for high-speed data increasing, it would be beneficial if applications could utilize both DDS/nDDS SIM cards together. Additionally, the HLOS, e.g., HLOS 202, assigns all applications to one SIM card, i.e. the DDS/SIM card 212, for sending/receiving data traffic, even if another SIM card, e.g., SIM card 222, is available.

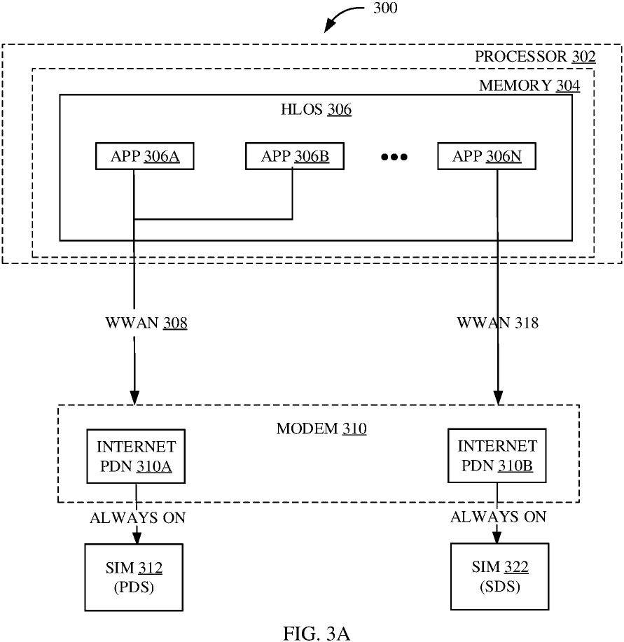

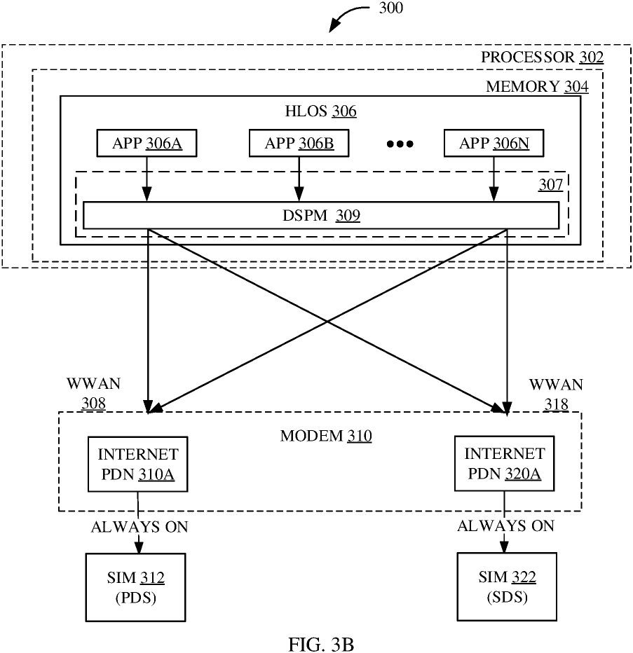

In light of the above, embodiments of the present disclosure present a new framework to support dual PS service, and to improve the user experience. FIG. 3A is a schematic representation of a UE 300 configured to support Dual PS service in accordance with some embodiments. Similar to UE 200 (FIG. 2), UE 300 may comprise a processor 302 or similar computing component capable of processing data. Hardware processor 302 may be one or more central processing units (CPUs), semiconductor-based microprocessors, and/or memory 304. HLOS 306 may be an operating system stored in memory 304 and executed by processor 302, whereby HLOS 306 controls or is involved in executing one or more applications (which may also be stored in memory 304), e.g., applications that may have a need to communicate with/via a network, such as an Internet packet data network 310A or 320A.

As illustrated in FIG. 3A, in contrast to UE 200 of FIG. 2, UE 300 can utilize two different/separate data connections, referenced as WWANs 308 and 318 that can be established and maintained between HLOS 306/the applications 306A-306N and respective modems 310 and 320, each associated with a different SIM card, i.e., SIM cards 312 and 322, respectively. In this example, data connection WWAN 308 can be effectuated between applications 306A and 306B/HLOS 206 and a modem 310 of UE 300 that maps to Internet PDN 310A (using, e.g., the PD protocol (PDP) or protocol data unit (PDU) session for accessing PS service. UE 300, having the capability to utilize multiple SIM cards, may establish another data connection WWAN 318 between application 306N and modem 310 that maps to Internet PDN 310B using, e.g., PDP or PDU, to access the PS service. In this case, SIM card 322 is used to establish the data connection. In some embodiments, an application itself may determine/decide which data connection/SIM card to utilize. In some embodiments, SIM cards 312 and 322, can be designated (or assigned) as primary and secondary DSs (PDS and SDS).

Ultimately, a UE, such as UE 300, can be configured to have two data connections between applications/HLOS and the UE modem at all times. Each connection can map to the Internet/an Internet PS service connection with each SIM card over the air, and transmit/receive data to/from the Internet vis-a-vis a network, such as a cellular network. In this way, both SIM cards of a DS device can be utilized/leveraged, rather than leaving one SIM card unused.

In some embodiments, UE 300 may be configured with a data subscription policy manager (DSPM) for managing the multiple/dual data connections. FIG. 3B is a schematic representation of UE 300, except that a DSPM 309 is implemented “between” apps 306A-306N and modem 310. Instead of designating SIM cards as DDS and nDDS, SIM cards of UE 300, e.g., again, SIM cards 312 and 322, can be designated (or assigned) as primary and secondary DSs. FIG. 3B illustrates that SIM card 312 is the PDS while SIM card 322 is the SDS, although selection of a SIM card to be the PDS or SDS can vary. In some embodiments, applications 306A-306N can request PS service access via DSPM 309. In particular an application may request access to a particular data service, which, as explained above, can be associated with one of two SIM cards, in this example SIM cards 312 and 322. It should be noted that in the event more than two SIM cards can/are used, embodiments of the present disclosure can be adapted to handle such scenarios.

DSPM 309 can be configured to provide access to a particular PDN via either the PDS (associated with SIM card 312) or the SDS (associated with SIM card 322). In some embodiments, DSPM 309 relies on a fixed assignment or mapping of application to PDS or SDS. For example, memory 304 may further comprise a table, matrix, or other mechanism for associating particular applications (one or more of applications 306A-306N) with one of SIM card 312/PDS or SIM card 322/SDS. That is, when an application requests access to a PS service, DSPM 309 can determine the associated SIM card 312 or 322, and effectuate a connection between the requesting application and the appropriate SIM card.

In some embodiments, DSPM 309 can establish a data connection/session between an application and a PDS or SDS based on dynamic selection of one of the PDS or SDS. It should be understood that the “primary” and “secondary” distinctions/labels are not necessarily indicative of a preference for use, although in some embodiments, some priorities/preferences may impact selection of a DS for use by an application.

In other words, in some embodiments, DSPM 309 may consider certain factors when effectuating dynamic selection/assignment of an application to a DS. For example, the aforementioned priorities/preferences may be a basis for DS/SIM card selection. In other embodiments, single or multiple considerations such as load, resource usage, processing capacity, current status, etc. can be taken into account by DSPM 309. Thus, when an application, such as application 306B requests access to PS service, DSPM 309 can determine the identity or operating characteristics needed/associated with requesting application 306B. DSPM 309 can consider the relevant factors, e.g., application 306B is identified as being an application that has video data queued for transmission, necessitating low latency/high quality of service. In this example, SIM card 322/SDS may have more bandwidth to support the transmission of video data, and thus, DSPM 309 selects SIM card 322/SDS for use by application 306B. Tables, data stores, or similar mechanisms may be used to store and maintain information/relevant characteristics/etc., and can be accessed by DSPM 309 to make the above-described selection determination.

In still other embodiments, both SIM cards 312 and 322 may be used together/simultaneously. For example, as illustrated in FIG. 3B, DSPM 309 may optionally utilize multiple SIM cards/designated DSs to provide PS service to one or more applications 306A-306N. For example, application 306A may have some amount of data to transmit, and to improve throughput, DSPM 309 may, if possible, utilize both SIM cards 312 and 322 to effectuate a data communication session. In other words, and similar to dynamic selection, DSPM 309 can consider various factors/requirements/desired operating characteristics to determine if aggregated DS is appropriate.

In some embodiments, dynamic selection of a DS can occur on an as-needed basis or in response to operating conditions/characteristics. That is, an application may opt to switch to using a different SIM card/DS while the application is in use. In some embodiments, DSPM 309 may rely on information regarding the status of the network, network element (such as a base station or access point of a PDN) through which communications are to be transmitted, desired quality of service, etc., as a basis (es) for selecting a particular SIM card/DS for use. For example, a link status meter (LSM) refers to a mechanism commonly used to determine link quality/signal strength of an access point. DSPM 309 may leverage the information provided in LSM output to determine when/whether to switch an application to another link. In this way, load/traffic can be better balanced between WWANs 308 and 318 (referring to the example of FIG. 3). Moreover, quality of service can be improved, e.g., switching links to avoid issues occurring on one link, and/or better recovery from abnormal operations can be realized. For example, the ability to switch between DSs/SIM cards may allow time for a down network link to be repaired.

It should be understood that DPSM 309 can be implemented in, e.g., an application processor of the UE 300, e.g., application processor 307. In some embodiments application processor 307 may be separate from other processors, such as a system on a chip (SoC) used for supporting the applications running on UE 300. Although not illustrated, it should be understood that the embodiment illustrated in FIG. 3A may also include an application processor. It should be further understood that in the event, some requisite characteristic(s)/operating condition(s) are not specified, DSPM 309 can, on it’s own, based on its assessment of link quality/usage/etc. determine a data connection to assign to an application.

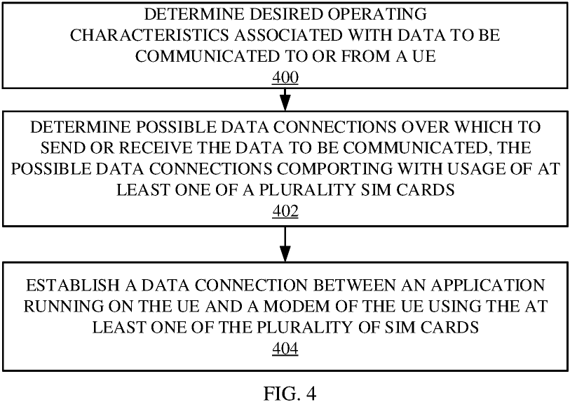

FIG. 4 illustrates example operations that may be performed to support dual PS service in a UE in accordance with some embodiments.

At operation 400, desired operating characteristics associated with data to be communicated to/from a UE are determined. As discussed above, a subscription manager, such as DSPM 309 (FIG. 3B) may consider certain factors when selecting one (or both) data connections established using one (or both) installed SIM cards of the UE, e.g., priorities/preferences (whether communications or user/UE-driven), load, resource usage, etc. Again, when an application requests access to PS service, the subscription manager can determine the identity or operating characteristics needed/associated with the requesting application/communications.

At operation 402, the possible data connections over which to send or receive the data to be communicated are determined. The possible data connections comport with usage of at least one of a plurality of SIM cards. The SIM cards installed in the UE allow communications to occur according to a particular DS. Because the SIM cards are “always on” or active, limitations associated with conventionally-configured UEs (due, at least, to the HLOS of such UEs not supporting separate data paths to the modem), can be avoided. Moreover, both SIM cards can be used simultaneously to effectuate data connections for use by one or more applications.

At operation 404, a data connection between an application running on the UE and a modem of the UE using the at least one of the plurality of SIM cards. That is, upon determining the proper/desired DS/SIM card to use to effectuate a data connection, the data connection is set up/initiated to proceed with the communication of the data over the data connection. As discussed above, an application, the subscription manager, or the resources used to effectuate communications may be operating in a non-optimal manner, e.g., latency/delays may be experienced, quality of service may be less-than-ideal, etc. Thus, because both SIM cards of the UE are always operational, the SIM card used to support current data communications can be switched. In this way, applications that use/rely on PS service can be more flexibly implemented/supported by virtue of having access to either or both SIM cards. Moreover, the quality of service/user experience can be improved by virtue of utilizing a SIM card(s) that optimize the communication of data/operational characteristics.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

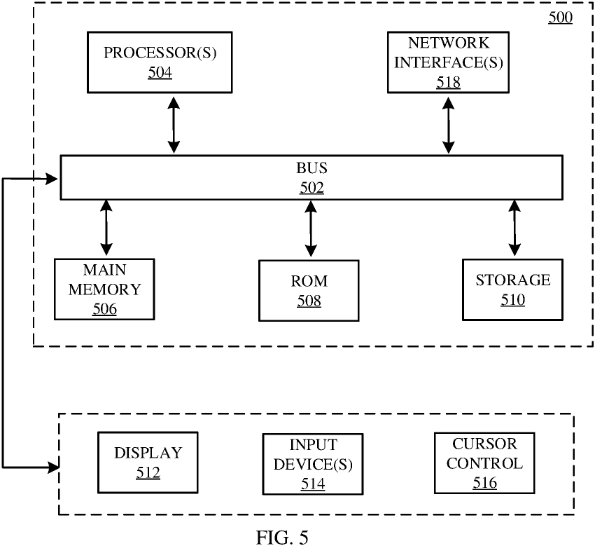

FIG. 5 is an example computing component that may be used to implement various features of embodiments described in the present disclosure. FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a solid state disk (SSD), magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, bitstreams, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes communication interface 518 coupled to bus 502. Communication interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicate with a WAN). Wireless links may also be implemented. In any such implementation, communication interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A user equipment (UE), comprising:
a processor; and
a memory unit operatively connected to the processor and including instructions that when executed cause the processor to:
determine desired operating characteristics associated with data to be communicated to or from the UE;
determine possible data connections over which to send or receive the data to be communicated, the possible data connections comporting with usage of at least one of a plurality of subscriber identity module (SIM) cards installed in the UE; and
establish a data connection between an application running on the UE and a modem of the UE using the at least one of the plurality of SIM cards.

2. The UE of claim 1, wherein each of the SIM cards installed in the UE is associated with a data subscription.

3. The UE of claim 2, wherein a first of the SIM cards is associated with a primary data subscription and wherein a second of the SIM cards is associated with a secondary data subscription.

4. The UE of claim 1, wherein each of the plurality of SIM cards operates in an always-on mode relative to a modem of the UE.

5. The UE of claim 1, wherein the determination of the desired operating characteristics associated with data to be communicated to or from the UE is performed repeatedly.

6. The UE of claim 4, wherein the determination of the possible data connections depends on updated determinations resulting from the repeated determination of the desired operating characteristics.

7. The UE of claim 6, wherein the instructions that when executed establish the data connection between the application running on the UE and the modem of the UE using the at least one of the plurality of SIM cards further comprise establishing another data connection between the application running on the UE and the modem of the UE using the other of the at least one of the plurality of SIM cards.

8. The UE of claim 6, wherein the instructions that when executed establish the data connection between the application running on the UE and the modem of the UE using the at least one of the plurality of SIM cards further comprise establishing simultaneously-used data connections between the application running on the UE and the modem of the UE using each of the plurality of SIM cards.

9. The UE of claim 6, wherein the instructions that when executed establish the data connection between the application running on the UE and the modem of the UE using the at least one of the plurality of SIM cards further comprise establishing another data connection between the application running on the UE and the modem of the UE using the other of the at least one of the plurality of SIM cards, and switching between the data connection and the other data connection.

10. A user equipment (UE), comprising:
a processor; and
a memory unit operatively connected to the processor, and including instructions which when executed by the processor comprise a data subscription policy manager to:
receive a request from an application being executed by the processor to access a packet switched service;
determine desired operating characteristics associated with the access to the packet switched service;
select a data path over which to send or receive the data according to the desired operating characteristics by utilizing at least one of a plurality of always-on subscriber identity module (SIM) cards installed in the UE to establish the data path over a network; and
establish the data path between the application and the packet switched service.

11. The UE of claim 10, wherein selection of the data path is based on a determined mapping between the application and the one of the plurality of always-on SIM cards.

12. The UE of claim 10, wherein selection of the data path is dynamic based on the determined desired operating characteristics.

13. The UE of claim 10, wherein the desired operating characteristics comprise at least one of application-specific operating characteristics, UE-specific operating characteristics, and network-specific operating characteristics.

14. The UE of claim 10, wherein the instructions that when executed establish the data path between the application and the packet switched service further comprise establishing another data path between the application and packet switched service using another one of the plurality of SIM cards.

15. The UE of claim 10, wherein the instructions that when executed establish the data path between the application and the packet switched service further comprise establishing simultaneously-used data paths between the application and at least one of the packet switched service and another packet switched service.

16. The UE of claim 10, wherein the instructions that when executed establish the data path between the application and the packet switched service further comprise establishing another data path between the application and at least one of the packet switched service and another packet switched service, and switching between the data path and the other data path.

17. A method, comprising:
determining desired operating characteristics associated with data to be communicated to or from user equipment (UE);
determining possible data connections over which to send or receive the data to be communicated, the possible data connections comporting with usage of at least one of a plurality of subscriber identity module (SIM) cards installed in the UE; and
establishing a data connection between an application running on the UE and a packet switched service via a modem of the UE using the at least one of the plurality of SIM cards.

18. The method of claim 17, wherein each of the plurality of SIM cards is in an always-on mode of operation.

19. The method of claim 17, wherein the determining of the possible data connections is based on a mapping of the application to the one of the plurality of SIM cards.

20. The method of claim 17, wherein the determining of the possible data connections is dynamically performed based on the determined desired operating characteristics.
